(19) United States
(12) Patent Application Publication
(10) Pub. No.: US 2019/0325295 A1
(43) Pub. Date: Oct. 24, 2019

(54) TIME, SPACE, AND ENERGY EFFICIENT NEURAL INFERENCE VIA PARALLELISM AND ON-CHIP MEMORY

(71) Applicant: INTERNATIONAL BUSINESS MACHINES CORPORATION, Armonk, NY (US)

(72) Inventors: Dharmendra S. Modha, San Jose, CA (US); John V. Arthur, Mountain View, CA (US); Jun Sawada, Austin, TX (US); Steven K. Esser, San Jose, CA (US); Rathinakumar Appuswamy, San Jose, CA (US); Brian Taba, Cupertino, CA (US); Andrew S. Cassidy, San Jose, CA (US); Pallab Datta, San Jose, CA (US); Myron D. Flickner, San Jose, CA (US); Hartmut Penner, San Jose, CA (US); Jennifer Klamo, San Jose, CA (US)

(21) Appl. No.: 15/958,588

(22) Filed: Apr. 20, 2018

(51) Int. Cl. G06N 3/063; G06N 3/04

(52) U.S. Cl. CPC G06N 3/063; G06N 3/04

(57) ABSTRACT

Neural inference chips and cores adapted to provide time, space, and energy efficient neural inference via parallelism and on-chip memory are provided. In various embodiments, the neural inference chips comprise: a plurality of neural cores interconnected by an on-chip network; a first on-chip memory for storing a neural network model, the first on-chip memory being connected to each of the plurality of cores by the on-chip network; a second on-chip memory for storing input and output data, the second on-chip memory being connected to each of the plurality of cores by the on-chip network.

### BACKGROUND

Embodiments of the present disclosure relate to neural networks, and more specifically, to neural inference chips and cores adapted to provide time, space, and energy efficient neural inference via parallelism and on-chip memory.

### BRIEF SUMMARY

According to embodiments of the present disclosure, neural inference chips are provided. In various embodiments, the neural inference chips comprise: a plurality of neural cores interconnected by an on-chip network; a first on-chip memory for storing a neural network model, the first on-chip memory being connected to each of the plurality of cores by the on-chip network; a second on-chip memory for storing input and output data, the second on-chip memory being connected to each of the plurality of cores by the on-chip network.

According to embodiments of the present disclosure, methods of and computer program products for operating a neural network are provided. A neural network model is read from a first on-chip memory on a neural inference chip. A plurality of neural cores on the neural inference chip is configured according to the neural network model. Input is read from a second on-chip memory on the neural inference chip. The input is provided to the plurality of neural cores. The input is transformed into an output by the plurality of neural cores. The output are written to the second on-chip memory on the neural inference chip.

According to embodiments of the present disclosure, methods of and computer program products for configuring a neural inference chip are provided. Prior to runtime, a neural network model is loaded to a first on-chip memory on a neural inference chip. During runtime, a plurality of neural cores on the neural inference chip is configured according to the neural network model. During runtime, a second on-chip memory on the neural inference chip is updated with input data. The input data are transformed to output data by the plurality of neural cores. The output data are written to the second on-chip memory on the neural inference chip.

According to embodiments of the present disclosure, methods of and computer program products for operating a neural inference chip are provided. Input data are written to a second memory of the neural inference chip. In some embodiments, input data are written by a host of the neural inference chip. The input data are provided to a plurality of neural cores of the neural inference chip. For each of a plurality of layers of a neural network defined by a neural network model in a first memory of the neural inference chip: a portion of the neural network model is provided from the first memory to the plurality of neural cores; a portion of instructions are provided from a fourth memory of the neural inference chip to the neural cores; and, the input data are transformed into output data by the plurality of neural cores. The output data from the plurality of neural cores are aggregated. The aggregated output data are written to the second memory. In some embodiments, intermediate results are communicated among the plurality of neural cores. In some embodiments, the aggregated output data are read from the second memory by a host of the neural inference chip.

### BRIEF DESCRIPTION OF THE SEVERAL VIEWS OF THE DRAWINGS

FIG. 1 depicts a neural inference chip according to embodiments of the present disclosure.

FIG. 2 depicts a neural inference chip according to embodiments of the present disclosure.

FIG. 3 depicts a neural inference chip according to embodiments of the present disclosure.

FIG. 4 depicts a neural inference chip according to embodiments of the present disclosure.

FIG. 5 depicts a neural inference chip according to embodiments of the present disclosure.

FIG. 6 depicts a neural inference chip according to embodiments of the present disclosure.

FIG. 7 depicts a neural inference chip according to embodiments of the present disclosure.

FIG. 8 depicts a method for operating a neural inference chip according to embodiments of the present disclosure.

FIG. 9 depicts a computing node according to an embodiment of the present invention.

### DETAILED DESCRIPTION

An artificial neuron is a mathematical function whose output is a nonlinear function of a linear combination of its inputs. Two neurons are connected if the output of one is an input to the other. A weight is a scalar value encoding the strength of the connection between the output of one neuron and the input of another neuron.

A neuron computes its output, called an activation, by applying a nonlinear activation function to a weighted sum of its inputs. A weighted sum is an intermediate result computed by multiplying each input with the corresponding weight and accumulating the products. A partial sum is a weighted sum of a subset of inputs. A weighted sum of all inputs may be computed in stages by accumulating one or more partial sums.

A neural network is a collection of one or more neurons. A neural network is often divided into groups of neurons called layers. A layer is a collection of one or more neurons that all receive input from the same layers and all send output to the same layers, and typically perform a similar function. An input layer is a layer that receives input from a source outside the neural network. An output layer is a layer that sends output to a target outside the neural network. All other layers are intermediate processing layers. A multilayer neural network is a neural network with more than one layer. A deep neural network is a multilayer neural network with many layers.

A tensor is a multidimensional array of numerical values. A tensor block is a contiguous subarray of the elements in a tensor.

Each neural network layer is associated with a weight tensor, parameter tensor, input tensor, output tensor, and intermediate tensor. The weight tensor contains all of the weights that connect inputs to the layer. The parameter tensor contains all of the parameters that control neuron activation functions in the layer. The input tensor contains all of the data that the layer consumes as input. The output tensor contains all of the data that the layer computes as output. The intermediate tensor contains any data that the layer produces as intermediate computations, such as partial sums.

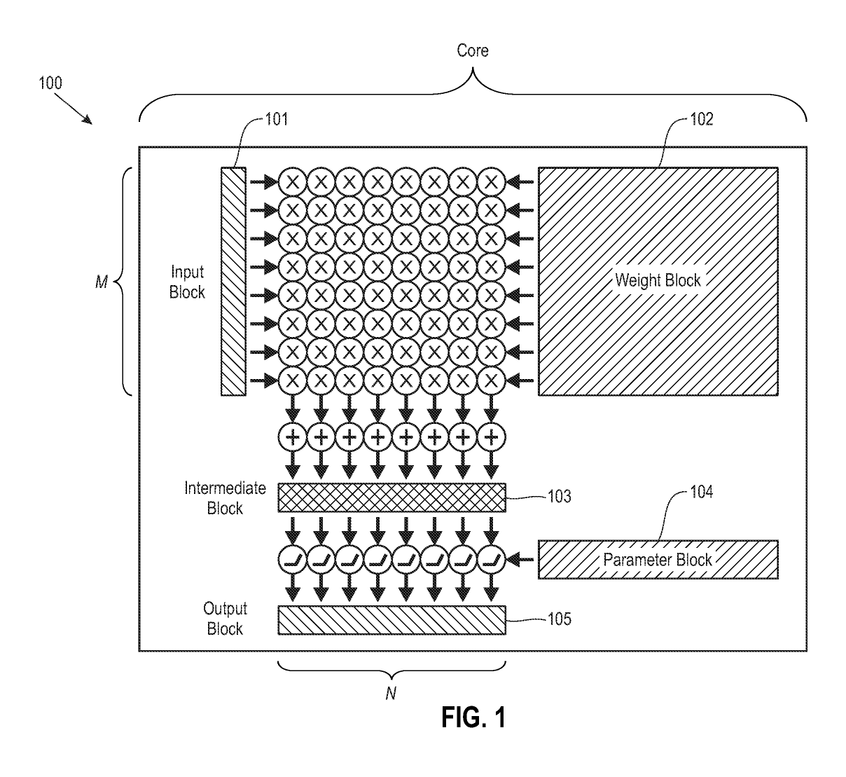

With reference now to FIG. 1, a neural core according to embodiments of the present disclosure is depicted. A neural core 100 is a tileable computational unit that computes one block of an output tensor. A neural core 100 has M inputs and N outputs. In various embodiments, M=N. To compute an output tensor block, a neural core multiplies an M×1 input tensor block 101 with an M×N weight tensor block 102 and accumulates the products into weighted sums that are stored in a 1×N intermediate tensor block 103. A U×N parameter tensor block contains the U parameters that specify each of the N neuron activation functions that are applied to the intermediate tensor block 103 to produce a 1×N output tensor block 105.

Multiple neural cores may be tiled in a neural core array. In some embodiments, the array is 2-dimensional.

A neural network model is a set of constants that collectively specify the entire computation performed by a neural network, including the graph of connections between neurons as well as the weights and activation function parameters for every neuron. Training is the process of modifying the neural network model to perform a desired function. Inference is the process of applying a neural network to an input to produce an output, without modifying the neural network model.

An inference processing unit is a category of processors that perform neural network inference. A neural inference chip is a specific physical instance of an inference processing unit.

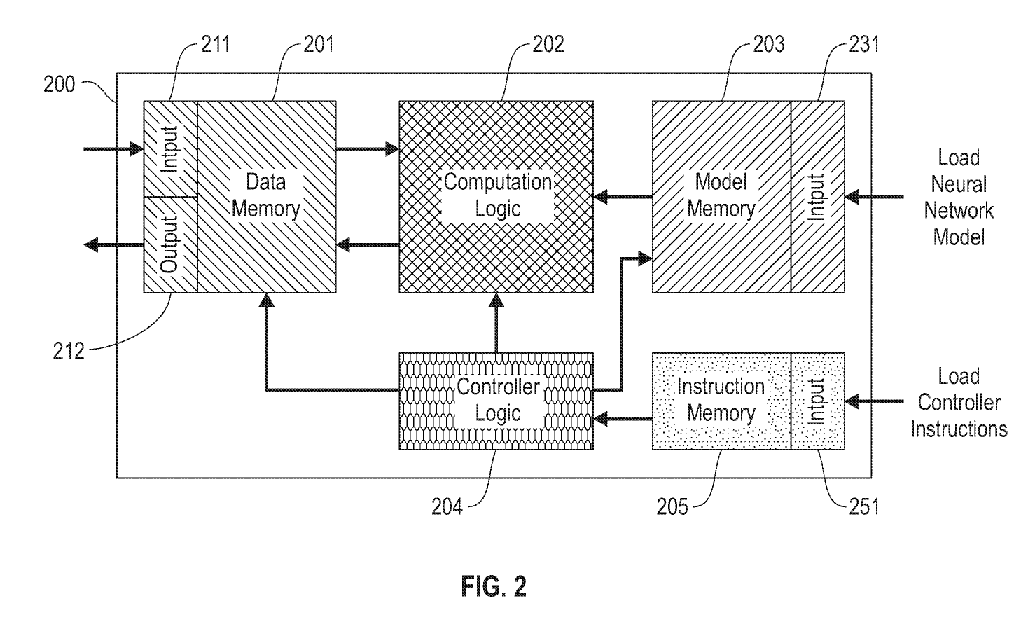

With reference now to FIG. 2, a neural inference chip according to embodiments of the present disclosure is depicted. Chip 200 includes a data memory 201 for storing data during operation of the chip. Memory 201 accommodates input 211 and output 212, which in some embodiments are addressable from off-chip. Chip 200 includes computation logic 202, which may include one or more neural cores configured to implementing intermediate processing layers within a multi-layer neural network. Chip 200 includes model memory 203 for storing the neural network model, which may include configuration parameters for computation logic 202. Model memory 203 accommodates input 231, which in some embodiments is addressable from off-chip. Chip 200 includes controller logic 204, which defines the transformation operations and directs the flow of data between the on-chip memory and computation logic. Chip 200 includes instruction memory 205 for storing instructions that are executed by the control logic. Instruction memory 205 includes input 251, which in some embodiments is addressable from off-chip. An on-chip network (not pictured) is provided for interconnecting these components.

With the memory 202, 201, 205 provided on chip 200 for the neural network model, transient data, and controller instructions, there is no need for off-chip memory access during computation, with the exception of receiving input 211 and sending output 212. Accordingly, chip 200 is fast and energy-efficient in comparison to alternative approaches that do not provide such on-chip memory.

Computation logic 202 may include one or more neural cores. In such embodiments, the cores are connected by an on-chip network to allow direct communication of intermediate and final computations to other cores.

As set out below, in various embodiments, on-chip components may be centralized outside an array of cores, as pictured in FIG. 2. In other embodiments, on-chip components are distributed in part among the cores.

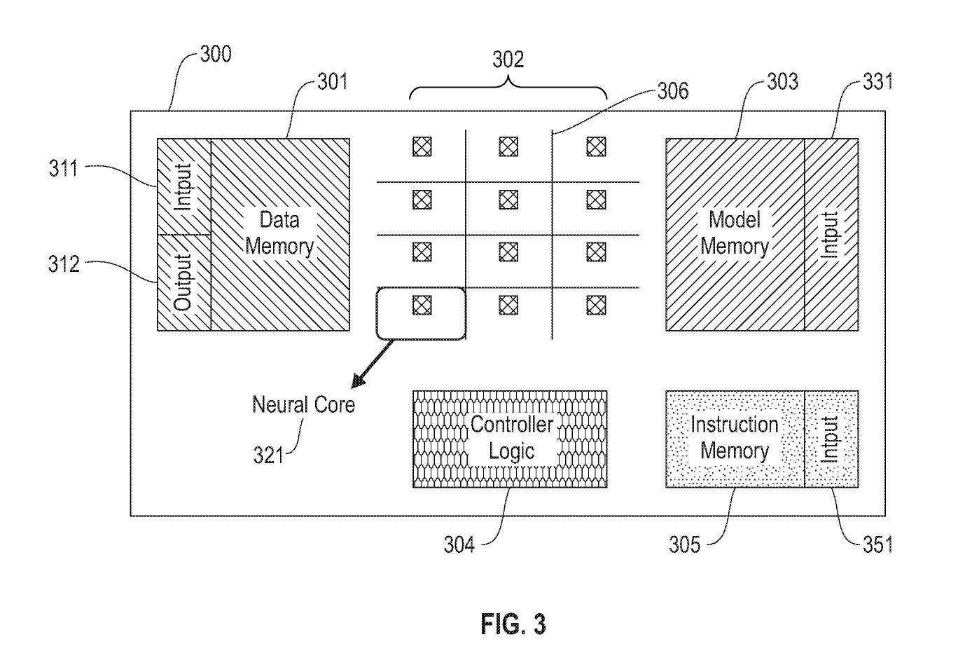

With reference now to FIG. 3, a neural inference chip according to embodiments of the present disclosure is depicted. Chip 300 includes a data memory 301 for storing data during operation of the chip. Memory 301 accommodates input 311 and output 312, which in some embodiments are addressable from off-chip. Chip 300 includes computation logic 302, which includes one or more neural cores 321 configured to implementing intermediate processing layers within a multi-layer neural network. Chip 300 includes model memory 303 for storing the neural network model, which may include configuration parameters for computation logic 302. Model memory 303 accommodates input 331, which in some embodiments is addressable from off-chip. Chip 300 includes controller logic 304, which defines the transformation operations and directs the flow of data between the on-chip memory and computation logic. Chip 300 includes instruction memory 305 for storing instructions that are executed by the control logic. Instruction memory 305 includes input 351, which in some embodiments is addressable from off-chip. An on-chip network 306 is provided for interconnecting these components.

In this embodiment, computation is distributed among multiple cores 321.

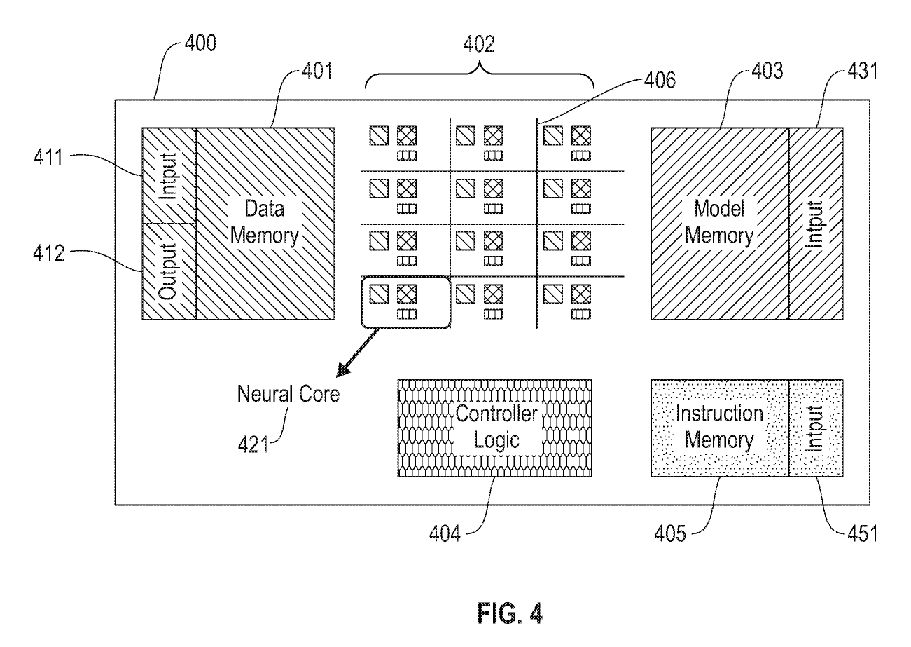

With reference now to FIG. 4, a neural inference chip according to embodiments of the present disclosure is depicted. Chip 400 includes a data memory 401 for storing data during operation of the chip. Memory 401 accommodates input 411 and output 412, which in some embodiments are addressable from off-chip. Chip 400 includes computation logic 402, which includes one or more neural cores 421 configured to implementing intermediate processing layers within a multi-layer neural network. Chip 400 includes model memory 403 for storing the neural network model, which may include configuration parameters for computation logic 402. Model memory 403 accommodates input 431, which in some embodiments is addressable from off-chip. Chip 400 includes controller logic 404, which defines the transformation operations and directs the flow of data between the on-chip memory and computation logic. Chip 400 includes instruction memory 405 for storing instructions that are executed by the control logic. Instruction memory 405 includes input 451, which in some embodiments is addressable from off-chip. An on-chip network 406 is provided for interconnecting these components.

In this embodiment, computation is distributed among multiple cores 321. Controller logic and data memory are partially distributed among multiple cores 321. Accordingly, there is both chip-level controller logic 404 and data memory 401 and per-core controller logic and data memory.

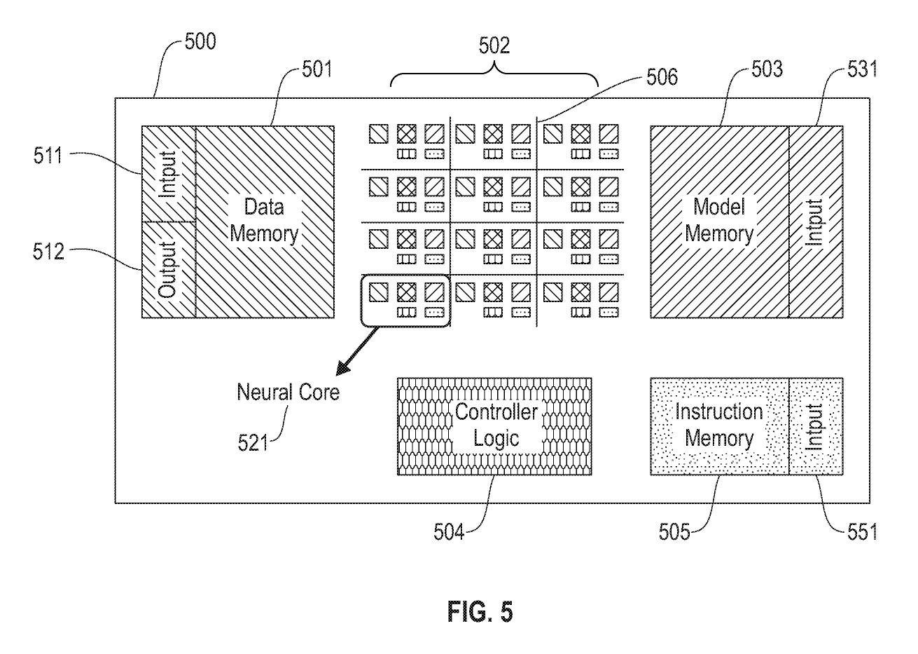

With reference now to FIG. 5, a neural inference chip according to embodiments of the present disclosure is depicted. Chip 500 includes a data memory 501 for storing data during operation of the chip. Memory 501 accommodates input 511 and output 512, which in some embodiments are addressable from off-chip. Chip 500 includes computation logic 502, which includes one or more neural cores 521 configured to implementing intermediate processing layers within a multi-layer neural network. Chip 500 includes model memory 503 for storing the neural network model, which may include configuration parameters for computation logic 502. Model memory 503 accommodates input 531, which in some embodiments is addressable from off-chip. Chip 500 includes controller logic 504, which defines the transformation operations and directs the flow of data between the on-chip memory and computation logic. Chip 500 includes instruction memory 505 for storing instructions that are executed by the control logic. Instruction memory 505 includes input 551, which in some embodiments is addressable from off-chip. An on-chip network 506 is provided for interconnecting these components.

In this embodiment, computation is distributed among multiple cores 521. Controller logic, data memory, model memory, and instruction memory are partially distributed among multiple cores 521. Accordingly, there is both chip-level controller logic 504, data memory 501, model memory 503, and instruction memory 505 and corresponding per-core entities.

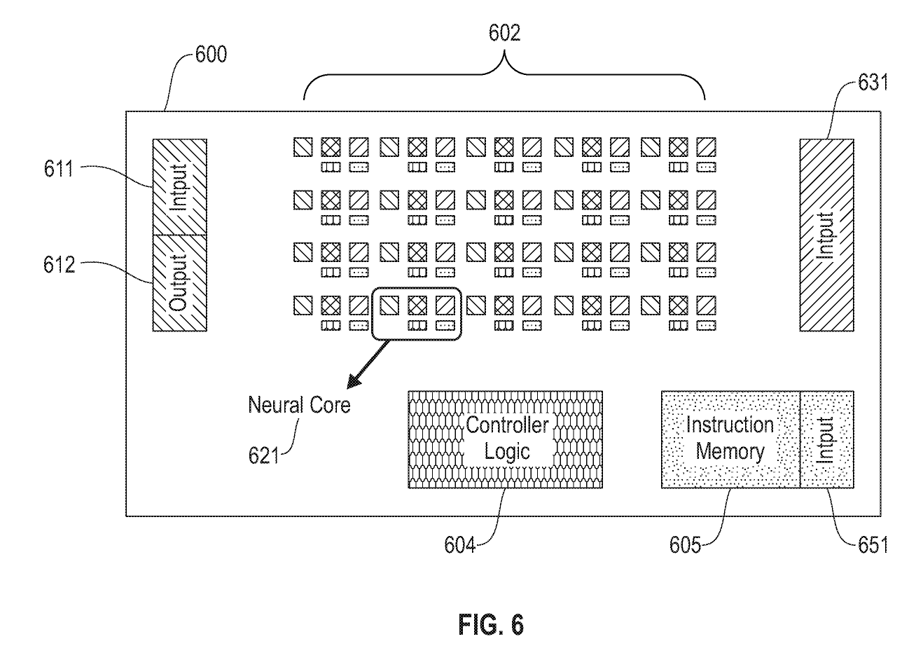

With reference now to FIG. 6, a neural inference chip according to embodiments of the present disclosure is depicted. Chip 600 accommodates input 611 and output 612, which in some embodiments are addressable from off-chip. Chip 600 includes computation logic 602, which includes one or more neural cores 621 configured to implementing intermediate processing layers within a multi-layer neural network. Chip 600 accommodates input 631, which in some embodiments is addressable from off-chip. Chip 600 includes controller logic 604, which defines the transformation operations and directs the flow of data between the on-chip memory and computation logic. Chip 600 includes instruction memory 605 for storing instructions that are executed by the control logic. Instruction memory 605 includes input 651, which in some embodiments is addressable from off-chip. An on-chip network (not pictured) is provided for interconnecting these components.

In this embodiment, computation is distributed among multiple cores 621. Data memory and model memory are also distributed among multiple cores 621 without having corresponding chip-level entities. Accordingly, input 611 and output 612 are coupled via the on-chip network to the multiple data memory entities on the various cores 621. Likewise, input 631 is coupled via the on-chip network to the multiple model memory entities on the various cores 621. Controller logic and instruction memory are partially distributed among multiple cores 621. Accordingly, there is both chip-level controller logic 604 and instruction memory 605 and corresponding per-core entities.

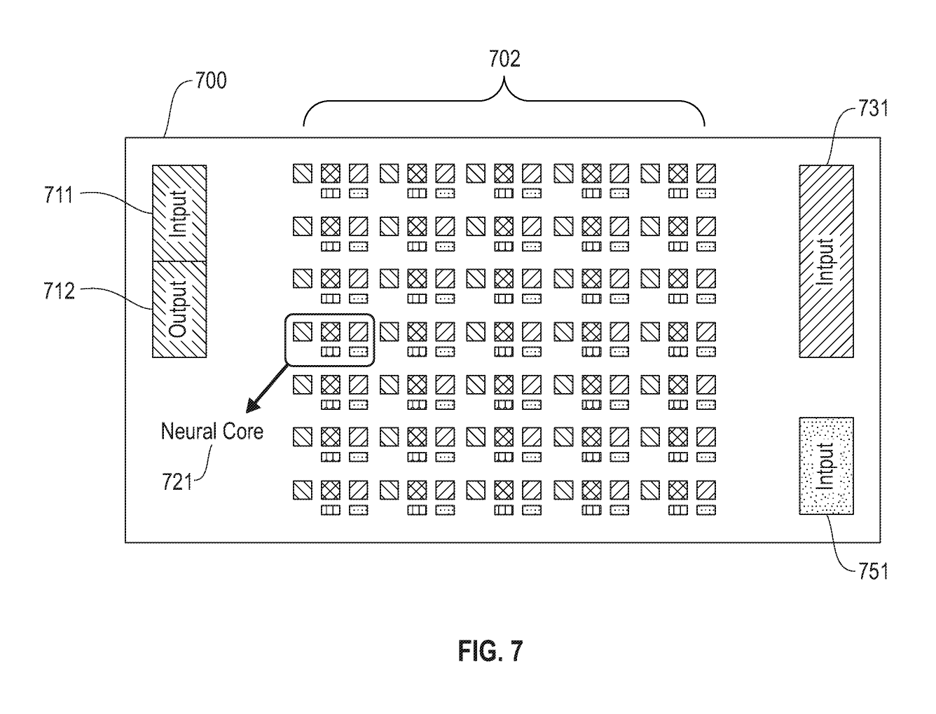

With reference now to FIG. 7, a neural inference chip according to embodiments of the present disclosure is depicted. Chip 700 accommodates input 711 and output 712, which in some embodiments are addressable from off-chip. Chip 700 includes computation logic 702, which includes one or more neural cores 721 configured to implementing intermediate processing layers within a multi-layer neural network. Chip 700 accommodates input 731, which in some embodiments is addressable from off-chip. Chip 700 accommodates input 751, which in some embodiments is addressable from off-chip. An on-chip network (not pictured) is provided for interconnecting these components.

In this embodiment, computation is distributed among multiple cores 721. Data memory, controller logic, instruction memory, and model memory are also distributed among multiple cores 721 without having corresponding chip-level entities. Accordingly, input 711 and output 712 are coupled via the on-chip network to the multiple data memory entities on the various cores 721. Likewise, input 731 is coupled via the on-chip network to the multiple model memory entities on the various cores 721 and input 751 is coupled via the on-chip network to the multiple instruction memory entities on the various cores 721.

Various embodiments described above provide distributed logic for computation. In various embodiments, multiple distributed neural cores act in parallel. This parallelism enables an increase in the speed of neural network processing while decreasing latency between presentation of input and computation of output. Each neural core implements a part of the larger neural network model for a given problem. Each neural core receives a portion of the overall chip input, and a portion of the overall neural network model. This enables modularity of chips and cores, thereby streamlining system design, debugging, and testing.

Various embodiments described above provide distributed memory for input and output data. Because data memory is distributed to neural cores, memory and computation are further localized, thus reducing energy of data movement. In particular, alternative approaches that provide only off-chip memory expend significant energy in transporting data onto and off of a chip, and to each individual core. In some embodiments, data memory is provided at the chip level, and subset of data are then provided to individual neural cores. In some embodiments, data memory is provided both at the chip level and at each core. In such embodiments, some or all of the chip-level data memory contents may be cached in the memory of each core, thereby providing data locality. In some embodiments, memory is provided at the core level. In some such embodiments, memory is duplicated from core to core. In some embodiments, the memory of all cores is combined in a single virtual memory.

Various embodiments described above provide a distributed neural network model, as noted with regard to the model memory on each chip. Individual portions of the overall neural network model are distributed to the neural cores. By distributing portions of the memory storing the neural network model to respective cores, the need to transmit it from a central location is minimized. Common or reused portions of the neural network model may be stored centrally, and send to the individual cores when needed. In this way, cores may be dynamically reconfigured for a given task. Likewise, each core need not be provided with the entire neural network model, thereby minimizing energy costs.

Accordingly, the present disclosure provides chips suitable for implementing neural networks. Such neural networks may provide inference and prediction based on input data, and may include one or more interconnected intermediate processing layers. In particular, in a neural network model, multiple layers may be included between the input and output layers. Various such arrangements are known in the art. As described above, various embodiments of a neural inference chip include on-chip memory for storing the neural network model, on-chip memory for storing input and output data, on-chip memory for storing transient data from intermediate processing layers, computation logic for implementing intermediate processing layers, control logic that specifies the transformation operations and directs the flow of data between the on-chip memory and computation logic, on-chip memory for storing the instructions that are executed by the control logic, and on-chip networks for interconnecting components.

In some embodiments, the computation logic is organized as an array of one or more neural cores that can directly communicate intermediate and final computations to other neural cores via one or more networks-on-chip.

As described with reference to the figures above, each of the components of the neural inference chip may be distributed among the neural cores, centralized outside the neural core array, or partially distributed and partially centralized.

In various embodiments, the neural inference chip transforms input data into output data by applying one or more layers of computation specified by a neural network model. In some such embodiments, the outputs of intermediate processing layers are stored in the data memory.

In some embodiments, the parameters required to compute each intermediate layer are stored in the neural network model memory. For example, in some embodiments, the parameters include synaptic weights or synaptic activation functions.

In some embodiments the computation implemented by each neural core may be reconfigured online by loading a different set of parameters from the neural network model memory. As noted above, the neural network model memory may be local to each neural core, centralized on the chip, or partially distributed and partially centralized.

In some embodiments, the input to each neural core may be reconfigured online by loading data from various addresses in the data memory. In this way, serial inputs to the neural network may be provided from on-chip memory without expending the time or energy for off-chip access.

In various embodiments, the memory for the neural network model is configured offline prior to the chip being used for inference. In some embodiments, the memory for the instructions is likewise configured offline. In some embodiments, the memory for the input and output data is updated online while the chip is being used for inference. In some embodiments, the memory for the transient data from intermediate processing layers is updated online.

In various embodiments, the memory for the neural network model may additionally be configured or updated online. Likewise, in some embodiments, the memory for the instructions may additionally be configured or updated online.

In general, the operation of chips according to the present disclosure may be broken down into online and offline phases—that is, during computation and not during computation. As noted above, in some embodiments, chip configuration is performed offline. During chip configuration, a neural network model is loaded onto the chip. This neural network model may have been handcrafted, or may have been learned offline using a learning algorithm (e.g., deep learning or reinforcement learning). A list of controller instructions, or a controller program, is loaded onto the chip. This controller program may have been handcrafted, or may have been compiled automatically from a higher-level design language.

Once the chip is configured offline by loading a neural network model, it is ready to perform neural network inference in an online fashion at runtime. During this phase, an input or a sequence of inputs are presented to the chip, with the chip respectively producing an output or a sequence of outputs. The chip is able to transform the input to the output without any off-chip instructions or programs and without needing any off-chip memory for storing transient data from intermediate processing layers.

In various embodiments, communication with neural cores is provided through one or more on-chip network. In various embodiments, the on-chip network is used to distribute the neural network model from centralized model memory to the neural cores. In various embodiments, the on-chip network is used to distribute the controller instructions from centralized instruction memory to the neural cores. In various embodiments, the on-chip network is used to distribute input data to the neural cores and to aggregate output data from the neural cores.

In various embodiments having multiple neural cores, the on-chip network communicates intermediate computations between neighboring neural cores. Likewise, in various embodiments having multiple neural cores, the on-chip network communicates transient data from intermediate processing layers between neighboring neural cores.

Each neural core implements a part of the overall neural network model, according to the portion loaded to it from the central model memory. The cores collaborate via the on-chip network to achieve a full result. In various embodiments, the on-chip network provides various levels of connectivity between the cores. In some embodiments, the cores are fully interconnected. In some embodiments, neural cores communicate only with cores to their left, their right, their top, and their bottom.

As described above, in various embodiments, controller logic is provided on-chip. In some embodiments, the control logic is implemented as a programmable controller that orchestrates the entire chip's operation, as defined by an instruction set architecture. In some embodiments, the controller is centralized, executing a programmable microcode at the overall chip level. In some embodiments, the controller is distributed among the neural cores, each executing a programmable microcode at the core level. In some embodiments, the controller is hierarchical, having components that execute instructions at multiple levels of granularity (e.g., centralized chip-level, distributed core-level, and zero or more levels in between). In some embodiments, centralized controller components execute chip-level instructions to distribute core-level instructions to the controller components in each neural core.

In various embodiments, the controller is programmable. Accordingly, chip-level instructions and core-level instructions jointly specify the operation of the chip. Chip-level and core-level instructions ensure that the entire chip operation and each core's operations are pipelined for very high throughput. In various embodiments, the instruction set architecture includes control instructions to orchestrate the chip's operation. For example, instructions may include generating neural network memory addresses and read/write operations, specifying the computation operations to be executed on the data, specifying the routing of data between cores and between cores and memories, generating input, output, and data memory addresses, and read/write operations.

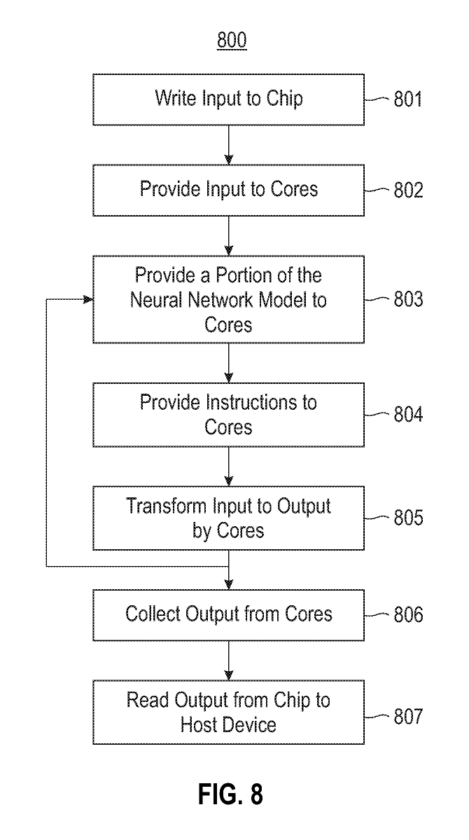

Referring now to FIG. 8, a method of operating a neural inference chip is illustrated according to embodiments of the present disclosure. At 801, input data are written to a second memory of the neural inference chip. In some embodiments, input data are written by a host of the neural inference chip. At 802, the input data are provided to a plurality of neural cores of the neural inference chip. For each of a plurality of layers of a neural network defined by a neural network model in a first memory of the neural inference chip: at 803, a portion of the neural network model is provided from the first memory to the plurality of neural cores; at 804, a portion of instructions are provided from a fourth memory of the neural inference chip to the neural cores; and, at 805, transforming the input data into output data by the plurality of neural cores. At 806, the output data from the plurality of neural cores are aggregated. At 807, the aggregated output is written to the second memory. In some embodiments, intermediate results are communicated among the plurality of neural cores. In some embodiments, the aggregated output data are read from the second memory by a host of the neural inference chip.

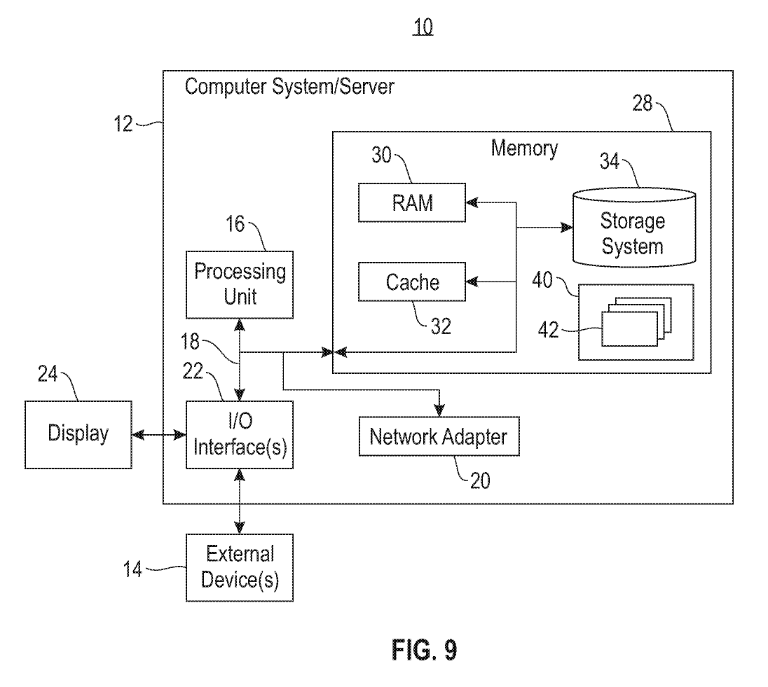

Referring now to FIG. 9, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A neural inference chip comprising:
a plurality of neural cores interconnected by an on-chip network;
a first on-chip memory for storing a neural network model, the first on-chip memory being connected to each of the plurality of cores by the on-chip network;
a second on-chip memory for storing input and output data, the second on-chip memory being connected to each of the plurality of cores by the on-chip network.

2. The neural inference chip of claim 1, further comprising:
at least one controller connected to the plurality of neural cores, the first on-chip memory, and the second on-chip memory;
a third on-chip memory for storing controller instructions, the third on-chip memory being connected to the at least one controller.

3. The neural inference chip of claim 2, wherein the at least one controller is connected to the plurality of neural cores, the first on-chip memory, and the second on-chip memory via the on-chip network.

4. The neural inference chip of claim 1, wherein each of the plurality of neural cores further comprises: a local memory for storing a portion of the neural network model.

5. The neural inference chip of claim 1, wherein each of the plurality of neural cores further comprises: a local memory for storing a portion of the input and output data.

6. The neural inference chip of claim 1, wherein each of the plurality of neural cores further comprises: a local memory for storing controller instructions.

7. The neural inference chip of claim 1, wherein each of the plurality of neural cores further comprises: a local controller.

8. The neural inference chip of claim 1, wherein the plurality of neural cores forms an array.

9. The neural inference chip of claim 8, wherein each of the plurality of cores is connected to adjacent cores within the array by the on-chip network.

10. A neural inference chip comprising:
an array of one or more neural cores;
a first memory for storing a neural network model;
a second memory for storing input and output data;
a third memory for storing transient data;
a fourth memory for storing controller instructions; and
at least one on-chip network, wherein
the neural network model comprises one or more interconnected processing layers adapted to transform input data into output data,
each of the array of one or more neural cores is adapted to directly communicate intermediate data to other of the array of one or more neural cores via the at least one on-chip network,
the neural inference chip is adapted to execute the controller instructions to control transformation operations applied by the array of one or more neural cores and to direct flow of data between the array of one or more neural cores and the memories.

11. The neural inference chip of claim 10, wherein each of the neural cores comprises at least a local portion of the first memory, the second memory, the third memory, or the fourth memory.

12. The neural inference chip of claim 10, wherein the first memory, the second memory, the third memory, or the fourth memory is distributed among the neural cores.

13. The neural inference chip of claim 10, wherein the first memory, the second memory, the third memory, or the fourth memory comprise portions local to the neural cores and a centralized portion.

14. The neural inference chip of claim 10, wherein the controller instructions are executed by one or more controller.

15. The neural inference chip of claim 14, wherein each of the neural cores comprises a local controller.

16. The neural inference chip of claim 14, further comprising a centralized controller.

17. The neural inference chip of claim 14, further comprising a centralized controller, wherein each of the neural cores comprises a local controller.

18. The neural inference chip of claim 10, wherein the at least one on-chip network is adapted to:
distribute the neural network model from the first memory to the neural cores;
distribute the controller instructions from the fourth memory to the neural cores;
distribute input data to the neural cores; and
aggregate output data from the neural cores.

19. The neural inference chip of claim 14, wherein the controller is programmable according to an instruction set.

20. The neural inference chip of claim 17, wherein the centralized controller is adapted to execute chip-level instructions and the local controllers are adapted to execute core-level instructions.

21. The neural inference chip of claim 17, wherein the centralized controller is adapted to distribute core-level instruction to the local controllers.

22. The neural inference chip of claim 10, wherein the first memory, second memory, third memory, or fourth memory is updated online, during inference.

23. The neural inference chip of claim 10, wherein:
the first memory and second memories are configured offline, in advance of inference.

24. The neural inference chip of claim 10, adapted to:
reconfigure online by modifying the neural network model in the first memory.

25. The neural inference chip of claim 10, adapted to:
reconfigure online by modifying the controller instructions in the fourth memory.

26. The neural inference chip of claim 10, adapted to:
reconfigure the neural cores online by loading neural network parameters from the first memory to the neural cores.

27. The neural inference chip of claim 10, adapted to:
reconfigure input to the neural cores online by loading data from the third on-chip memory for the transient data from intermediate processing layers of the neural network model.

28. A method of operating a neural inference chip, the method comprising:
writing input data to a second memory of the neural inference chip;
providing the input data to a plurality of neural cores of the neural inference chip;
for each of a plurality of layers of a neural network defined by a neural network model in a first memory of the neural inference chip:
providing a portion of the neural network model from the first memory to the plurality of neural cores,
providing a portion of instructions from a fourth memory of the neural inference chip to the neural cores, and
transforming the input data into output data by the plurality of neural cores;
aggregating the output data from the plurality of neural cores; and
writing the aggregated output data to the second memory.

29. The method of claim 28, further comprising communicating intermediate results among the plurality of neural cores.

30. The method of claim 28, further comprising:
reading the aggregated output data from the second memory by a host of the neural inference chip.
